(19) United States
(12) Patent Application Publication
(10) Pub. No.: US 2025/0313692 A1
(43) Pub. Date: Oct. 9, 2025

(54) MULTISTAGE POLYMER, ITS METHOD OF PREPARATION, COMPOSITION COMPRISING IT AND ITS USE

(71) Applicant: ARKEMA FRANCE, COLOMBES (FR)

(72) Inventors: Aline COUFFIN, Lacq (FR); Rabi INOUBLI, Cedex (FR); Alexandre VERMOGEN, Cedex (FR)

(73) Assignee: ARKEMA FRANCE, COLOMBES (FR)

(21) Appl. No.: 18/723,287

(22) PCT Filed: Dec. 21, 2022
(86) PCT No.: PCT/EP2022/087285

§ 371 Date: Jun. 21, 2024

(30) Foreign Application Priority Data
Dec. 23, 2021 (FR) 2114419

(51) Int. Cl. C08L 33/12; C08F 120/14; C08J 3/12

(52) U.S. Cl. CPC C08L 33/12; C08F 120/14; C08J 3/126; C08J 2333/12; C08J 2433/12; C08L 2207/53

(57) ABSTRACT

The present invention relates to a composition comprising a multistage polymer, its process of preparation, composition comprising it and its use.

In particular the present invention relates to a composition in form of a polymer powder comprising a multistage polymer in form of polymeric particles made by a multistage process and a (meth)acrylic polymer.

More particularly the present invention relates to polymer composition in form of a porous polymer powder comprising polymeric particles made by a multistage process comprising at least two stages and a (meth)acrylic polymer, its process of preparation, its use and compositions and articles comprising it.

### FIELD OF THE INVENTION

The present invention relates to a composition comprising a multistage polymer, its process of preparation, composition comprising it and its use.

In particular the present invention relates to a composition in form of a polymer powder comprising a multistage polymer in form of polymeric particles made by a multistage process and a (meth)acrylic polymer.

More particularly the present invention relates to polymer composition in form of a porous polymer powder comprising polymeric particles made by a multistage process comprising at least two stages and a (meth)acrylic polymer, its process of preparation, its use and compositions and articles comprising it.

### Technical Problem

Polymers are widely used also as additives in polymer compositions. These so called polymer additives are usually added as granulate or also as powder, either to solid polymers, or to molten polymers or to liquid resins or to liquid compositions.

One class of polymeric additives are processing aids, another one are polymeric impact modifiers.

Polymeric impact modifiers can be in form of polymeric particles. Usually these polymeric impact modifiers are in form of core-shell particles that are made by a multistage process, with at least one stage comprising a rubber like polymer. Afterwards these particles are incorporated in the polymers or polymer compositions, in order to increase their impact resistance. The polymers or polymer compositions can be thermoset ones or thermoplastic ones.

Thermosetting polymers consist of crosslinked three-dimensional structures. The crosslinking is obtained by curing reactive groups inside the so-called prepolymer. Curing for example can be obtained by heating the polymer chains or prepolymer in order to crosslink and harden the material permanently.

Thermoplastic polymers consist of linear or branched polymers, which are usually not cross-linked. They might be slightly cross-linked as long as they can be deformed by heat. However, these before mentioned core-shell particles are not easy to disperse or fast to disperse in all kind of resins or polymers or precursors to polymers, especially for example in liquid epoxy resins or liquid monomers or other liquid polymeric precursors.

A good homogenous and fast dispersion is necessary for having satisfying impact performance in the final polymeric composition. An easy dispersion making and fast dispersion time is also required to reduce the process time and gain on an easier simpler process.

An objective of the present invention is to propose a polymeric composition which is rapidly and easily dispersible, especially in liquid resins as for example precursors for thermoset polymers or thermoplastic polymers as respectively for instance in epoxy resins or in (meth)acrylic monomers.

An objective of the present invention is to propose a polymeric composition in form of a polymer powder which is rapidly and easily dispersible, especially in liquid resins as for example precursors for thermoset polymers or thermoplastic polymers as respectively for instance in epoxy resins or in (meth)acrylic monomers.

An additional objective of the present invention is to propose a polymeric composition in form of a dry polymer powder which is easily dispersible, especially in low polar liquid resins or low polar (meth)acrylic monomers.

An objective of the present invention is also to propose a multistage polymer composition in form of a dry polymer powder which is easily dispersible, especially in low polar liquid resins or low polar (meth)acrylic monomers.

An additional objective of the present invention is to propose a multistage polymer composition in form of a dry polymer powder which is easily dispersible in reactive epoxy resins, polyester resins or (meth)acrylic resins/polymers or liquid monomers or resins.

Another objective of the present invention is to propose a process for making a multistage polymer composition in form of a polymer powder which is easily dispersible in in reactive epoxy resins, polyester resins or (meth)acrylic resins/polymers or liquid monomers or resins, especially in low polar liquid resins or low polar (meth)acrylic monomers.

Still another objective of the present invention is the use of a polymeric composition in form of a polymer powder for preparing a liquid composition comprising precursors for thermoset polymers or thermoplastic polymers.

Still another objective is to reduce the time of dispersing a polymer powder in such a liquid composition.

### [BACKGROUND OF THE INVENTION] PRIOR ART

The document WO2016/102666 discloses a composition comprising a multistage polymer and its method of preparation. The composition comprises as well a (meth)acrylic polymer that has a mass average molecular weight of less than 100 000 g/mol. The (meth)acrylic polymer can comprise a functional monomer unit.

The document WO2016/102682 discloses a multistage polymer composition and its method of preparation. The multistage polymer comprises a last stage that comprises a (meth)acrylic polymer that has a mass average molecular weight of less than 100 000 g/mol. The (meth)acrylic polymer can comprise a functional monomer unit

The document FR 2934866 discloses polymer preparation of a specific core shell polymers with functional shell comprising hydrophilic monomers. The core shell polymers are used as impact modifier in thermoset polymers.

The document WO2019/012052 discloses a composition comprising a multistage polymer and its method of preparation. The composition comprises as well a (meth)acrylic polymer that has a mass average molecular weight between 100 000 g/mol and 1 000 000 g/mol. The (meth)acrylic polymer can comprise a functional monomer unit.

None of the prior art documents discloses composition comprising a multistage polymer combined with a (meth)acrylic polymer, both polymers comprising monomer units either comprising an alicyclic hydrocarbon group with a carbon number from 3 to 20 or chosen according to its Hansen solubility parameter δₚ<10 MPa^{1/2} or a process for preparing it.

### BRIEF DESCRIPTION OF THE INVENTION

Surprisingly it has been found that a polymer composition (PC1) comprising
a) a polymer (A1) having a glass transition temperature of less than 10° C.,
b) a polymer (B1) having a glass transition temperature of at least 60° C., and
c) a polymer (C1) having a glass transition temperature of at least 30° C., said polymer (C1) represents at most 40 wt % of a composition based on a), b) and c) only,
   characterized in that at least the component a) and the component b) of composition (PC1) are part of a multistage polymer (MP1),
   and in that the polymer (C1) has a mass average molecular weight Mw between 10 000 g/mol and 500 000 g/mol,
   and in that the polymer (B1) and the polymer (C1) comprise monomer units comprising an alicyclic hydrocarbon group with a carbon number from 3 to 20; yields to a polymer composition that can be easily dispersed in low polar liquid compositions and yielding to a liquid composition possessing a lower viscosity compared to a liquid composition with a polymer composition comprising no monomer units comprising an alicyclic hydrocarbon group with a carbon number from 3 to 20.

Surprisingly it has also been found that a polymer composition (PC1) comprising
a) a polymer (A1) having a glass transition temperature of less than 10° C.,
b) a polymer (B1) having a glass transition temperature of at least 60° C., and
c) a polymer (C1) having a glass transition temperature of at least 30° C., said polymer (C1) represents at most 40 wt % of a composition based on a), b) and c) only,
   characterized in that at least the component a) and the component b) of composition (PC1) are part of a multistage polymer (MP1),
   and in that the polymer (C1) has a mass average molecular weight Mw between 10 000 g/mol and 500 000 g/mol,
   and in that the polymer (B1) and the polymer (C1) comprise monomer units from polymerized comonomers (Mc_{b1}) and (Mc_{c1}) respectively both comonomers having a Hansen solubility parameter δₚ<10 MPa^{1/2}; yields to a polymer composition that can be easily dispersed in low polar liquid compositions and yielding to a liquid composition possessing a lower viscosity compared to a liquid composition with a polymer composition comprising no monomer units from polymerized comonomers (Mc_{b1}) and (Mc_{c1}) respectively both comonomers having a Hansen solubility parameter δₚ<10 MPa^{1/2}.

Surprisingly it has been found that a polymer composition (PC1) comprising a multistage polymer in form of a polymer powder comprising
a) a polymer (A1) having a glass transition temperature of less than 10° C.,
b) a polymer (B1) having a glass transition temperature of at least 60° C., and
c) a polymer (C1) having a glass transition temperature of at least 30° C., said polymer (C1) represents at most 40 wt % of a composition based on a), b) and c) only,
   characterized in that at least the component a) and the component b) of composition (PC1) are part of a multistage polymer (MP1),
   and in that the polymer (C1) has a mass average molecular weight Mw between 10 000 g/mol and 500 000 g/mol,
   and in that either in that the polymer (B1) and the polymer (C1) comprise monomer units comprising an alicyclic hydrocarbon group with a carbon number from 3 to 20 or in that the polymer (B1) and the polymer (C1) comprise monomer units from polymerized comonomers (MC_{b1}) and (Mc_{c1}) respectively both comonomers having a Hansen solubility parameter δₚ<10 MPa^{1/2}; yields to a polymer composition that can be easily dispersed in low polar liquid compositions and yielding to a liquid composition possessing a lower viscosity compared to either a liquid composition with a polymer composition comprising no monomer units comprising an alicyclic hydrocarbon group with a carbon number from 3 to 20 or to liquid composition with a polymer composition comprising no monomer units from polymerized comonomers (Mc_{b1}) and (Mc_{c1}) respectively both comonomers having a Hansen solubility parameter δₚ<10 MPa^{1/2}

Surprisingly it has also been found that a process for manufacturing the polymer composition (PC1) in form of a polymer powder comprising the steps of
a) polymerizing by emulsion polymerization of a monomer or monomer mixture (Aₘ) to obtain one layer in stage (A) comprising polymer (A1) having a glass transition temperature of less than 10° C.;
b) polymerizing by emulsion polymerization of a monomer or monomer mixture (Bₘ) to obtain layer in stage (B) comprising a polymer (B1) having a glass transition temperature of at least 60° C.;
c) polymerizing by emulsion polymerization of a monomer or monomer mixture (Cm) to obtain a layer in a stage (C) comprising a polymer (C1) having a glass transition temperature of at least 30° C., so that said polymer (C1) represents at most 40 wt % of the composition based on a), b) and c) only;
d) coagulating the composition obtained in steps a) to c);

characterized in that the polymer (C1) has a mass average molecular weight Mw between 10 000 g/mol and 500 000 g/mol and the monomer or monomer mixture (Bₘ) and the monomer or monomer mixture (Cₘ), both mixtures comprise comonomers (Mc_{b1}) and (Mc_{c1}) respectively said comonomers (MC_{b1}) and (Mc_{c1}) comprising either an alicyclic hydrocarbon group with a carbon number from 3 to 20 or both comonomers having a Hansen solubility parameter δₚ<10 MPa^{1/2}; yields to a polymer composition that be easily dispersed in an low polar polymeric matrix material for thermosetting polymers or thermoplastic polymers or their respective precursors as liquid resins and/or monomers.

Surprisingly it has also been found that a process for manufacturing the polymer composition (PC1) in form of a polymer powder comprising the steps of
a) polymerizing by emulsion polymerization of a monomer or monomer mixture (Aₘ) to obtain one layer in stage (A) comprising polymer (A1) having a glass transition temperature of less than 10° C.;
b) polymerizing by emulsion polymerization of a monomer or monomer mixture (Bₘ) to obtain a layer in stage (B) comprising a polymer (B1) having a glass transition temperature of at least 60° C.;
both together steps a) and b) giving a multistage polymer (MP1) and step
c) blending the multistage polymer (MP1) with a polymer (C1) having a glass transition temperature of at least 30° C. said polymer (C1) represents at most 40 wt % of the composition based on a), b) and c) only;
d) coagulating the composition obtained in steps a) to c);
   characterized in that the polymer (C1) has a mass average molecular weight Mw between 10 000 g/mol and 500 000 g/mol and the monomer or monomer mixture (Bₘ) and the monomer or monomer mixture (Cₘ), both mixtures comprise comonomers (Mc_{b1}) and (Mc_{c1}) respectively said comonomers (MC_{b1}) and (Mc_{c1}) either comprising an alicyclic hydrocarbon group with a carbon number from 3 to 20 or both comonomers having a Hansen solubility parameter δₚ<10 MPa^{1/2}; yields to a polymer composition, that be easily dispersed in a low polar polymeric matrix material for thermosetting polymers or thermoplastic polymers or their respective precursors as liquid resins and/or monomers.

Surprisingly it has also been found that that a process for manufacturing a liquid polymer composition LPC1 comprising the steps of
a) providing said polymeric composition (PC1) in form of a porous polymer powder having total intruded volume of at least 1.2 ml/g as measured by mercury porosimetry,
b) bringing into contact the polymeric composition (PC1) with a liquid composition LC1,
   yields to a liquid polymer composition where the polymeric composition POW1 is homogenously and fastly dispersed in the liquid composition LC1.

### DETAILED DESCRIPTION OF THE INVENTION

According to a first aspect, the present invention relates to a polymer composition (PC1) comprising
a) a polymer (A1) having a glass transition temperature of less than 10° C.,
b) a polymer (B1) having a glass transition temperature of at least 60° C., and
c) a polymer (C1) having a glass transition temperature of at least 30° C. said polymer (C1) represents at most 40 wt % of a composition based on a), b) and c) only;
   characterized in that at least the component a) and the component b) of composition (PC1) are part of a multistage polymer (MP1), characterized that the polymer (C1) has a mass average molecular weight Mw between 10 000 g/mol and 500 000 g/mol and that the polymer (B1) and the polymer (C1) comprise monomer units comprising an alicyclic hydrocarbon group with a carbon number from 3 to 20.

According to a second aspect, the present invention relates to a polymer composition (PC1) comprising
a) a polymer (A1) having a glass transition temperature of less than 10° C.,
b) a polymer (B1) having a glass transition temperature of at least 60° C., and
c) a polymer (C1) having a glass transition temperature of at least 30° C. said polymer (C1) represents at most 40 wt % of a composition based on a), b) and c) only;
   characterized in that at least the component a) and the component b) of composition (PC1) are part of a multistage polymer (MP1), characterized that the polymer (C1) has a mass average molecular weight Mw between 10 000 g/mol and 500 000 g/mol and that the polymer (B1) and the polymer (C1) comprise monomer units from polymerized comonomers (Mc_{b1}) and (Mc_{c1}) respectively both comonomers having a Hansen solubility parameter δₚ<10 MPa^{1/2}.

According to a third aspect, the present invention relates to a polymer composition (PC1) comprising
a) a polymer (A1) having a glass transition temperature of less than 10° C.,
b) a polymer (B1) having a glass transition temperature of at least 60° C., and
c) a polymer (C1) having a glass transition temperature of at least 30° C. said polymer (C1) represents at most 40 wt % of a composition based on a), b) and c) only;
   characterized in that at least the component a) and the component b) of composition (PC1) are part of a multistage polymer (MP1), characterized that the polymer (C1) has a mass average molecular weight Mw between 10 000 g/mol and 500 000 g/mol and either in that the polymer (B1) and the polymer (C1) comprise monomer units comprising an alicyclic hydrocarbon group with a carbon number from 3 to 20 or in that the polymer (B1) and the polymer (C1) comprise monomer units from polymerized comonomers (MC_{b1}) and (Mc_{c1}) respectively both comonomers having a Hansen solubility parameter δₚ<10 MPa^{1/2}.

According to a fourth aspect, the present invention relates to a process for manufacturing the polymer composition (PC1) comprising the steps of
a) polymerizing by emulsion polymerization of a monomer or monomer mixture (Aₘ) to obtain one layer in a stage (A) comprising polymer (A1) having a glass transition temperature of less than 10° C.,
b) polymerizing by emulsion polymerization of a monomer or monomer mixture (Bₘ) to obtain a layer in a stage (B) comprising a polymer (B1) having a glass transition temperature of at least 60° C.,
c) polymerizing by emulsion polymerization of a monomer or monomer mixture (Cₘ) to obtain a layer in a stage (C) comprising a polymer (C1) having a glass transition temperature of at least 30° C. said polymer (C1) represents at most 40 wt % of the composition based on a), b) and c) only;
d) agglomerating the composition obtained in steps a) to c);
   characterized in that the polymer (C1) has a mass average molecular weight Mw between 10 000 g/mol and 500 000 g/mol and the monomer or monomer mixture (Bₘ) and the monomer or monomer mixture (Cₘ), both comprise monomers comprising an alicyclic hydrocarbon group with a carbon number from 3 to 20.

In a fifth aspect the present invention relates to a process for manufacturing the polymer composition (PC1) comprising the steps of
a) polymerizing by emulsion polymerization of a monomer or monomer mixture (Aₘ) to obtain one layer in a stage (A) comprising polymer (A1) having a glass transition temperature of less than 10° C.,
b) polymerizing by emulsion polymerization of a monomer or monomer mixture (Bₘ) to obtain layer in a stage (B) comprising a polymer (B1) having a glass transition temperature of at least 60° C.,
both together steps a) and b) giving a multistage polymer (MP1) and a step
c) blending multistage polymer (MP1) with a polymer (C1) having a glass transition temperature of at least 30° C. said polymer (C1) represents at most 40 wt % of the composition based on a), b) and c) only;
d) agglomerating the composition obtained in steps a) to c);
   characterized that the polymer (C1) has a mass average molecular weight Mw between 10 000 g/mol and 500 000 g/mol and in that the monomer or monomer mixture (Bₘ) comprise monomers comprising an alicyclic hydrocarbon group with a carbon number from 3 to 20 and the polymer (C1) comprise monomer units comprising an alicyclic hydrocarbon group with a carbon number from 3 to 20.

According to a sixth aspect, the present invention relates to a process for manufacturing the polymer composition (PC1) comprising the steps of
a) polymerizing by emulsion polymerization of a monomer or monomer mixture (Aₘ) to obtain one layer in a stage (A) comprising polymer (A1) having a glass transition temperature of less than 10° C.,
b) polymerizing by emulsion polymerization of a monomer or monomer mixture (Bₘ) to obtain a layer in a stage (B) comprising a polymer (B1) having a glass transition temperature of at least 60° C.,
c) polymerizing by emulsion polymerization of a monomer or monomer mixture (Cₘ) to obtain a layer in a stage (C) comprising a polymer (C1) having a glass transition temperature of at least 30° C. said polymer (C1) represents at most 40 wt % of the composition based on a), b) and c) only;
d) agglomerating the composition obtained in steps a) to c);
   characterized in that the polymer (C1) has a mass average molecular weight Mw between 10 000 g/mol and 500 000 g/mol and in that the monomer or monomer mixture (Bₘ) and the monomer or monomer mixture (Cₘ), both comprise comonomers (Mc_{b1}) and (Mc_{c1}) respectively both comonomers having a Hansen solubility parameter δₚ<10 MPa^{1/2}.

In a seventh aspect the present invention relates to a process for manufacturing the polymer composition (PC1) comprising the steps of
a) polymerizing by emulsion polymerization of a monomer or monomer mixture (Aₘ) to obtain one layer in a stage (A) comprising polymer (A1) having a glass transition temperature of less than 10° C.,
b) polymerizing by emulsion polymerization of a monomer or monomer mixture (Bₘ) to obtain layer in a stage (B) comprising a polymer (B1) having a glass transition temperature of at least 60° C.,
both together steps a) and b) giving a multistage polymer (MP1) and a step
c) blending multistage polymer (MP1) with a polymer (C1) having a glass transition temperature of at least 30° C. said polymer (C1) represents at most 40 wt % of the composition based on a), b) and c) only;
d) agglomerating the composition obtained in steps a) to c);
   characterized that the polymer (C1) has a mass average molecular weight Mw between 10 000 g/mol and 500 000 g/mol and in that the monomer or monomer mixture (Bₘ) comprise comonomers (Mc_{b1}) having a Hansen solubility parameter δₚ<10 MPa^{1/2} and the polymer (C1) comprise monomer units from polymerized commoner (Mc_{c1}) having a Hansen solubility parameter δₚ<10 MPa^{1/2}.

In an eighth aspect the present invention relates to the use of a polymer composition (PC1) as impact modifier.

In a ninth aspect the present invention relates to the use of a polymer composition (PC1) as a reduced dispersing time composition.

In a tenth aspect the present invention relates to a process to reduce the dispersing time of a polymer powder in a low polar liquid composition by using the polymeric composition (PC1) in form of a polymer powder.

In an eleventh aspect the present invention relates to a polymer composition PC2 comprising the polymer composition (PC1) as impact modifier.

In a twelfth aspect the present invention relates to a process to reduce the time of dispersing a polymeric composition (PC1) in a liquid composition comprising the steps of:
a) providing said polymeric composition (PC1) of any of aspects 1 to 3 in form of a porous polymer powder POW1 having total intruded volume of at least 1.2 ml/g as measured by mercury porosimetry,
b) bringing into contact the polymeric composition (PC1) with a liquid composition LC1.

By the term “polymer powder” as used is denoted a polymer in form of a powder comprising powder grains in the range of at least 1 μm, said powder grains are obtained by agglomeration of primary polymer particles comprising polymer or polymers, said primary polymer particles are in the nanometer range.

By the term “primary particle” as used is denoted a spherical polymer particle comprising particle in the nanometer range. Preferably the primary particle has a weight average particle size between 20 nm and 800 nm.

By the term “particle size” as used is denoted the volume average diameter of a particle considered as spherical.

By the term “thermoplastic polymer” as used is denoted a polymer that turns to a liquid or becomes more liquid or less viscous when heated and that can take on new shapes by the application of heat and pressure.

By the term “thermosetting polymer” as used is denoted a prepolymer in a soft, solid or viscous state that changes irreversibly into an infusible, insoluble polymer network by curing.

By the term “copolymer” as used is denoted that the polymer consists of at least two different monomer units.

By “multistage polymer” as used is denoted a polymer formed in sequential fashion by a multi-stage polymerization process. Preferred is a multi-stage emulsion polymerization process in which the first polymer is a first-stage polymer and the second polymer is a second-stage polymer, i.e., the second polymer is formed by emulsion polymerization in the presence of the first emulsion polymer, with at least two stages that are different in composition.

By the term “(meth)acrylic” as used is denoted all kind of acrylic and methacrylic monomers.

By the term “(meth)acrylic polymer” as used is denoted that the (meth)acrylic) polymer comprises essentially polymers comprising (meth)acrylic monomers that make up 50 wt % or more of the (meth)acrylic polymer.

By the term “dry” as used is denoted that the ratio of residual water is less than 1.5 wt and preferably less than 1.2 wt %.

By saying that a range from x to y in the present invention, it is meant that the upper and lower limit of this range are included, equivalent to at least x and up to y.

By saying that a range is between x and y in the present invention, it is meant that the upper and lower limit of this range are excluded, equivalent to more than x and less than y.

By the term “total intruded volume” as used is denoted the total volume intruded by liquid mercury according to ISO 15901-1:2016. This volume is cumulated and the analysis results show cumulated intruded volume in ml/g (cm³/g) as function of the applied pressure or the pore diameter. The total intruded volume is the volume intruded at the maximal applied pressure, which corresponds also to the smallest pores.

By the term “incremental intrusion” as used is denoted the volume intruded in ml/g between two certain pressures or two pore sizes. This incremental intrusion can also be expressed relatively to the total intruded volume in vol %.

With easily dispersed in liquid resins is meant that a homogenous dispersion is obtained. The distribution of the polymeric composition (PC1) is not homogenous if separation takes place after initial homogenization.

By the term “low polar” as used are denoted compounds that having a Hansen solubility parameter δₚ<10 MPa^{1/2}. The Hansen solubility parameters, reflect the physicochemical dissolution properties, also called capacities for solvation, of organic substances. Hansen solubility parameters can be calculated according to the approach proposed by Charles Hansen in the work with the title “Hansen Solubility Parameters: A user's handbook”, Second Edition (2007) Boca Raton, Fla.: CRC Press. ISBN 978-0-8493-7248-3. According to this approach, three parameters, called “Hansen parameters”: δ_{d}, δₚ and δₕ are sufficient for predicting the behavior of a solvent with respect to a given molecule. The parameter δ_{d} in MPa^{1/2}, quantifies the energy of the forces of dispersion between the molecules, i.e., the van der Waals forces. The parameter δₚ in MPa^{1/2}, represents the energy of the intermolecular dipolar interactions. Finally, the parameter δₕ in MPa^{1/2}, quantifies the energy derived from the intermolecular hydrogen bonds, i.e., the capacity to interact via a hydrogen bond. The sum of the squares of the three parameters corresponds to the square of the Hildebrand solubility parameter (δₜₒₜ).

With fast dispersed in liquid resins is meant that a homogeneous dispersion is obtained much faster than with a polymeric composition not having the specific composition and molecular weight of polymer (C1)

With regard to the polymer composition (PC1) according to the invention, it can be according to a first embodiment in form of a polymer powder (POW1), also referred to as polymer powder POW1, comprising a) the polymer (A1) having a glass transition temperature of less than 10° C., b) the polymer (B1) having a glass transition temperature of at least 60° C. and c) and the polymer (C1) having a glass transition temperature of at least 30° C.; where at least the component a) and the component b) of composition (PC1) are part of a multistage polymer (MP1), and characterized in that the polymer (C1) has a mass average molecular weight Mw between 10 000 g/mol and 500 000 g/mol and that that the polymer (B1) and the polymer (C1) comprise monomer units comprising an alicyclic hydrocarbon group with a carbon number from 3 to 20.

The component c) represents at most 40 wt % of a composition based on a) b) and c). Preferably the component c) represents at most 35 wt % of the composition based on a), b) and c); and more preferably at most 30 wt %.

In a first advantageously embodiment component c) represents less than 30 wt % of a composition based on a) b) and c).

In a second advantageously embodiment component c) represents less than 25 wt % of a composition based on a) b) and c).

In a third advantageously embodiment component c) represents less than 20 wt % of a composition based on a) b) and c).

Preferably the component c) represents more than 4 wt % of a composition based on a), b) and c). More preferably the component c) represents more than 5 wt % of the composition based on a), b) and c).

In a first advantageously embodiment component c) represents more than 6 wt % of a composition based on a) b) and c).

In a second advantageously embodiment component c) represents more than 8 wt % of a composition based on a) b) and c).

In a third advantageously embodiment component c) represents more than 10 wt % of a composition based on a) b) and c).

The respective upper and lower limits given in the previous paragraphs for the quantity of component c), can be combined in any combinations of one upper and one lower limit

Preferably the component c) represents between 4 wt % and 40 wt % of the composition based on a) b) and c). More preferably the component c) represents between 5 wt % and 35 wt % of the composition based on a), b) and c).

In a first advantageously embodiment component c) represents between 6 wt % and 30 wt % of a composition based on a) b) and c).

In a second advantageously embodiment component c) represents 7 wt % and less than 25 wt % of a composition based on a) b) and c).

In a third advantageously embodiment component c) represents between 10 wt % and 20 wt % of a composition based on a) b) and c).

At least the component a) and the component b) of composition (PC1) are part of a multistage polymer (MP1).

At least the component a) and the component b) are obtained by a multistage process comprising at least two stages (A) and (B) respectively; and these two, polymer (A1) and polymer (B1) form a multistage polymer.

With regard to the polymer powder (POW1), it has a volume median particle size D50 between 1 μm and 700 μm. Preferably the volume median particle size of the polymer powder is between 10 μm and 600 μm, more preferably between 15 μm and 550 μm and advantageously between 20 μm and 500 μm.

The D10 of the particle size distribution in volume is at least 7 μm and preferably 10 μm, more preferably 15 μm.

The D90 of the particle size distribution in volume is at most 1000 μm and preferably 950 μm, more preferably at most 900 μm and even more preferably at most 800 μm.

The porosity of the polymer composition (PC1) in form of a polymer powder (POW1) is expressed as total intruded volume or total cumulative intrusion (cumulative intruded volume) in millilitre (ml) of mercury per mass (g) of said polymer powder POW1. This is measured according to the norm ISO 15901-1: Evaluation of pore size distribution and porosity of solid materials by mercury porosity and gas adsorption—Part 1: mercury porosity. Preferably the porous polymer powder (POW1) of the invention has a total intruded volume or total cumulative intrusion of at least 1.2 ml/g, preferably 1.25 ml/g, more preferably 1.3 ml/g, even more preferably 1.35 ml/g. The total cumulative intrusion is taken into account until a pore size diameter of 0.005 μm. Preferably the total intruded volume or total cumulative intrusion is taken into account between a pore size diameter of 100 μm and 0.005 μm or a pressure between 0.01 MPa and 400 MPa.

The porous polymer powder (POW1) of the invention has a total intruded volume or total cumulative intrusion of at most 10 ml/g. Preferably the total intruded volume is at most 8 ml/g, more preferably at most 7 ml/g, even more preferably at most 6 ml/g, advantageously at most 5 ml/g, more advantageously at most 4 ml/g and most advantageously at most 3.5 ml/g.

The respective upper and lower limits given in the previous two paragraphs for total intruded volume or total cumulative intrusion of the porous polymer powder (POW1) of the invention, can be combined in any combinations of one upper and one lower limit.

Preferably the porous polymer powder (POW1) of the invention has a total intruded volume or total cumulative intrusion between 1.2 ml/g and 10 ml/g, more preferably between 1.25 ml/g and 8 ml/g, even more preferably between 1.3 ml/g and 7 ml/g, advantageously between 1.3 ml/g and 6 ml/g, more advantageously between 1.3 ml/g and 5 ml/g and more advantageously between 1.3 ml/g and 4 ml/g and most advantageously between 1.3 ml/g and 3.5 ml/g.

The incremental intrusion (incremental intruded volume) is the volume between two certain pore diameters. The incremental intrusion can be expressed as an absolute value also in ml/g or as a relative value es percentage of total intruded volume or total cumulative intrusion (which is taken into account between a pore size diameter of 100 μm and 0.005 μm).

Preferably the porous polymer powder (POW1) of the invention has a cumulative intrusion for a pore size above 10 μm (larger than 10 μm) of at least 0.9 ml/g, more preferably at least 1 ml/g.

Preferably the porous polymer powder (POW1) of the invention has an incremental intrusion between a pore size from 10 μm to 1 μm of at least 0.1 ml/g, more preferably at least 0.12 ml/g and even more preferably at least 0.15 ml/g.

The apparent bulk density of the polymer powder (POW1) is less than 0.60 g/cm³. Preferably the apparent bulk density is less than 0.45 g/cm³, more preferably less than 0.43 g/cm³, and even more preferably less than 0.41 g/cm³.

The apparent bulk density of the polymer powder (POW1) is more than 0.1 g/cm³. Preferably the apparent bulk density is more than 0.11 g/cm³, more preferably is more than 0.12 g/cm³, even more preferably more than 0.13 g/cm³.

The apparent bulk density of the polymer powder (POW1) is between 0.1 g/cm³ and 0.60 g/cm³. Preferably the apparent bulk density of the polymer powder (POW1) is between 0.15 g/cm³ and 0.45 g/cm³. Advantageously the apparent bulk density of the polymer powder POW1 is between 0.2 g/cm³ and 0.4 g/cm³.

The respective preferred embodiment of all the different characteristics of the porous polymer powder (POW1), can be combined in any combination.

With regard to the polymer composition (PC1) according to the invention, it can be according to a second embodiment be dispersed in a continuous phase, comprising a) the polymer (A1) having a glass transition temperature of less than 10° C., b) the polymer (B1) having a glass transition temperature of at least 60° C. and c) and the polymer (C1) having a glass transition temperature of at least 30° C.; where at least the component a) and the component b) of composition (PC1) are part of a multistage polymer (MP1), and characterized in that the polymer (C1) has a mass average molecular weight Mw between 10 000 g/mol and 500 000 g/mol and that either in that the polymer (B1) and the polymer (C1) comprise monomer units comprising an alicyclic hydrocarbon group with a carbon number from 3 to 20 or in that the polymer (B1) and the polymer (C1) comprise monomer units from polymerized comonomers (MC_{b1}) and (Mc_{c1}) respectively both comonomers having a Hansen solubility parameter δₚ<10 MPa^{1/2}; and d) a liquid composition LC1 as continuous phase wherein the polymer composition (PC1) is dispersed in.

The multistage polymer (MP1) of the composition (PC1) according to the invention has at least two stages (A) and (B) respectively; and these two, comprising polymer (A1) and polymer (B1) respectively that are different in their polymer composition.

In a variation, the polymer (C1) is also part of the multistage polymer (MP1). In this case the composition of polymer (C1) is different from the composition of polymer (A1) and polymer (B1).

The multistage polymer (MP1) is preferably in form of polymer particles PAR. These particles PAR are also called core-shell particles. For example the first stage comprising polymer (A1) forms the core, the second or all following stages form the respective shells. Such a multistage polymer (MP1) which is also called core-shell particle is preferred. If the multistage polymer (MP1) comprises only the polymer (A1) and polymer (B1) it is core-shell particle comprising one shell only. If the multistage polymer (MP1) comprises the polymer (A1), polymer (B1) and polymer (C1) it is core-shell particle comprising with at least two shells.

The particles PAR, comprised in the polymer composition (PC1) in form of a polymer powder (POW1) according to one embodiment or dispersed according to another embodiment are the primary particles.

The particles PAR have a weight average particle size between 15 nm and 900 nm. Preferably the weight average particle size of the polymer particle is between 20 nm and 800 nm, more preferably between 25 nm and 600 nm, still more preferably between 30 nm and 550 nm, again still more preferably between 35 nm and 500 nm, advantageously between 40 nm and 400 nm, even more advantageously between 75 nm and 350 nm and advantageously between 80 nm and 300 nm.

According to a first preferred embodiment, the primary polymer particles PAR are agglomerated and are giving the polymer composition (PC1) or a part of the polymer composition (PC1). In that case the polymer composition (PC1) of the invention is in form of a polymer powder, as described previously.

The polymer composition (PC1) according to the invention comprises a multistage polymer (MP1) comprising at least a) one stage (A) comprising a polymer (A1) having a glass transition temperature below 10° C., and at least b) one stage (B) comprising a polymer (B1) having a glass transition temperature over 60° C.

In a first preferred embodiment the stage (A) is the first stage of the at least two stages and the stage (B) comprising polymer (B1) is grafted on stage (A) comprising polymer (A1) or another intermediate layer.

In a second preferred embodiment, there could also be another stage before stage (A), so that stage (A) would also be a shell.

In a third preferred embodiment the polymer (C1) having a glass transition temperature over 30° C. is also part of the multistage polymer (MP1). There is also at least one stage (C). Preferably the stage (C) takes place after stage (B). More preferably stage (C) is the last stage and the polymer (C1) is the outer shell of the multistage polymer (MP1).

In a first embodiment the polymer (A1) having a glass transition temperature below 10° C. comprises at least 50 wt % of polymeric units coming from alkyl acrylate or alkyl acrylates and the stage (A) is the most inner layer of the polymer particle having the multilayer structure. In other words the stage (A) comprising the polymer (A1) is the core of the polymer particle.

With regard to the polymer (A1) of the first preferred embodiment, it is a (meth)acrylic polymer comprising at least 50 wt % of polymeric units coming from acrylic monomers. Preferably 60 wt % and more preferably 70 wt % of the polymer (A1) are acrylic monomers.

The acrylic comonomer in polymer (A1) comprises monomers chosen from C1 to C18 alkyl acrylates or mixtures thereof. More preferably the acrylic monomer in polymer (A1) comprises monomers of C2 to C12 alkyl acrylic monomers or mixtures thereof. Still more preferably the acrylic monomer in polymer (A1) comprises monomers of C₂ to C₈ alkyl acrylic monomers or mixtures thereof.

The polymer (A1) can comprise a comonomer or comonomers which are copolymerizable with the acrylic monomer, as long as polymer (A1) is having a glass transition temperature of less than 10° C.

The comonomer or comonomers in polymer (A1) are preferably chosen from (meth)acrylic monomers and/or vinyl monomers.

Most preferably the acrylic or methacrylic comonomers of the polymer (A1) are chosen from methyl acrylate, propyl acrylate, isopropyl acrylate, butyl acrylate, tert-butyl acrylate, methyl methacrylate, ethyl methacrylate, butyl methacrylate and mixtures thereof, as long as polymer (A1) is having a glass transition temperature of less than 10° C.

In a specific embodiment polymer (A1) is a homopolymer of butyl acrylate.

More preferably the glass transition temperature Tg of the polymer (A1) comprising at least 70 wt % of polymeric units coming from C₂ to C₈ alkyl acrylate is between −100° C. and 10° C., even more preferably between −80° C. and 0° C. and advantageously between −80° C. and −20° C. and more advantageously between −70° C. and −20° C.

In a second preferred embodiment the polymer (A1) having a glass transition temperature below 10° C. comprises at least 50 wt % of polymeric units coming from isoprene or butadiene and the stage (A) is the most inner layer of the polymer particle having the multilayer structure. In other words the stage (A) comprising the polymer (A1) is the core of the polymer particle.

By way of example, the polymer (A1) of the core of the second embodiment, mention may be made of isoprene homopolymers or butadiene homopolymers, isoprene-butadiene copolymers, copolymers of isoprene with at most 98 wt % of a vinyl monomer and copolymers of butadiene with at most 98 wt % of a vinyl monomer. The vinyl monomer may be styrene, an alkylstyrene, acrylonitrile, an alkyl (meth)acrylate, or butadiene or isoprene. In a preferred embodiment the core is a butadiene homopolymer.

More preferably the glass transition temperature Tg of the polymer (A1) comprising at least 50 wt % of polymeric units coming from isoprene or butadiene is between −100° C. and 10° C., even more preferably between −90° C. and 0° C., advantageously between −80° C. and 0° C. and most advantageously between −70° C. and −20° C.

In a third preferred embodiment the polymer (A1) is a silicone rubber based polymer. The silicone rubber for example is polydimethyl siloxane. More preferably the glass transition temperature Tg of the polymer (A1) of the second embodiment is between −150° C. and 0° C., even more preferably between −145° C. and −5° C., advantageously between −140° C. and −15° C. and more advantageously between −135° C. and −25° C.

The polymer (A1) having a glass transition temperature below 10° C. comprises monomer units, that have been polymerized. The polymer (A1) in general and respective polymers (A1) of the first, second and third preferred embodiment are prepared from the respective monomer or monomer mixture (Aₘ) yielding to the monomer units comprised polymer (A1).

With regard to the polymer (B1), mention may be made of copolymers comprising monomers with double bonds and/or vinyl monomers at least one of the monomers is either comprising an alicyclic hydrocarbon group with a carbon number from 3 to 20 or is chosen according to its Hansen solubility parameter δₚ<10 MPa^{1/2}. Preferably the polymer (B1) is a copolymer comprising at least two different polymerized monomers. Preferably the polymer (B1) is a (meth)acrylic copolymer, meaning that at least 50 wt % of the monomer units of the copolymer (B1) are (meth)acrylic.

The copolymer (B1) comprises a comonomer (Mc_{b1}) either said comonomer (Mc_{b1}) is comprising an alicyclic hydrocarbon group with a carbon number from 3 to 20 or said comonomer (Mc_{b1}) is having a Hansen solubility parameter δₚ<10 MPa^{1/2}. The comonomer (Mc_{b1}) in the copolymer (B1) can present between 1 wt % and 99 wt %, preferably between 1 wt % and 90 wt % and more preferably between 1 wt % and 50 wt %. Preferably the Hansen solubility parameter δₚ<9 MPa^{1/2}.

In a first still more preferred embodiment the copolymer (B1) comprises between 1 wt % and 40 wt % of comonomer units from comonomer (Mc_{b1}) comprising an alicyclic hydrocarbon group with a carbon number from 3 to 20. The comonomer (Mc_{b1}) comprising an alicyclic hydrocarbon group with a carbon number from 3 to 20 is preferably a (meth)acrylic monomer.

In a second still more preferred embodiment the copolymer (B1) comprises between 1 wt % and 40 wt % comonomer (Mc_{b1}) having a Hansen solubility parameter δₚ<10 MPa^{1/2}. The comonomer (Mc_{b1}) is preferably a (meth)acrylic monomer.

In a third still more preferred embodiment the copolymer (B1) comprises between 1 wt % and 40 wt % of a comonomer (Mc_{b1}) comprising an alicyclic hydrocarbon group with a carbon number from 3 to 20 and having a Hansen solubility parameter δₚ<10 MPa^{1/2}. The comonomer (Mc_{b1}) is preferably a (meth)acrylic monomer.

In a fourth still more preferred embodiment the copolymer (B1) comprises between 10 wt % and 40 wt % of a comonomer (Mc_{b1}) comprising an alicyclic hydrocarbon group with a carbon number from 3 to 20.

In a fifth still more preferred embodiment the copolymer (B1) comprises between 20 wt % and 40 wt % of a comonomer (Mc_{b1}) comprising an alicyclic hydrocarbon group with a carbon number from 3 to 20.

In a sixth still more preferred embodiment the copolymer (B1) comprises between 5 wt % and 35 wt % of a comonomer (Mc_{b1}) comprising an alicyclic hydrocarbon group with a carbon number from 3 to 20.

In an seventh still more preferred embodiment the copolymer (B1) comprises between 10 wt % and 40 wt % of a comonomer (Mc_{b1}) either comprising an alicyclic hydrocarbon group with a carbon number from 3 to 20 or having a Hansen solubility parameter δₚ<9 MPa^{1/2}. The comonomer (Mc_{b1}) is preferably a (meth)acrylic monomer.

In an eight still more preferred embodiment the copolymer (B1) comprises between 10 wt % and 40 wt % of a comonomer (Mc_{b1}) either comprising an alicyclic hydrocarbon group with a carbon number from 3 to 20 or having a Hansen solubility parameter δₚ<10 MPa^{1/2}. The comonomer (Mc_{b1}) is preferably a (meth)acrylic monomer.

In a ninth still more preferred embodiment the copolymer (B1) comprises between 20 wt % and 40 wt % of a comonomer (Mc_{b1}) either comprising an alicyclic hydrocarbon group with a carbon number from 3 to 20 or having a Hansen solubility parameter δₚ<10 MPa^{1/2}. The comonomer (Mc_{b1}) is preferably a (meth)acrylic monomer.

In a tenth still more preferred embodiment the copolymer (B1) comprises between 5 wt % and 35 wt % of a comonomer (Mc_{b1}) either comprising an alicyclic hydrocarbon group with a carbon number from 3 to 20 or having a Hansen solubility parameter δₚ<10 MPa^{1/2}. The comonomer (Mc_{b1}) is preferably a (meth)acrylic monomer.

Most preferably the other acrylic or methacrylic comonomers (Mc_{b2}) of the copolymer (B1) are chosen from methyl acrylate, ethyl acrylate, methyl methacrylate, ethyl methacrylate, butyl methacrylate and mixtures thereof, as long as copolymer (B1) is having a glass transition temperature of at least 60° C.

Advantageously the copolymer (B1) comprises at least 50 wt % of monomer units coming from methyl methacrylate as comonomer (Mc_{b2}), more advantageously 60 wt %.

Preferably the glass transition temperature Tg of the copolymer (B1) is between 60° C. and 150° C. The glass transition temperature of the copolymer (B1) is more preferably between 80° C. and 150° C., advantageously between 90° C. and 150° C. and more advantageously between 100° C. and 150° C.

Preferably the copolymer (B1) is grafted on the polymer made in the previous stage.

In certain embodiments, the copolymer (B1) is crosslinked.

The copolymer (B1) having a glass transition temperature of at least 60° C. comprises monomer units, that have been polymerized. The copolymer (B1) in general and in the respective embodiments is prepared from the respective monomers or monomer mixtures (Bₘ) including comonomers (Mc_{b1}) and (Mc_{b2}), yielding after polymerization to the copolymer (B1) with monomer units comprised in copolymer (B1).

With regard to the polymer (C1), it has a mass average molecular weight Mw of between 10 000 g/mol and 500 000 g/mol.

The polymer (C1), it has a mass average molecular weight Mw of more than 10 000 g/mol, preferably more than 10 500 g/mol, more preferably more than 11 000 g/mol, still more preferably more than 12 000 g/mol, advantageously more than 13 000 g/mol, more advantageously more than 14 000 g/mol and still more advantageously more than 15 000 g/mol.

The polymer (C1), it has a mass average molecular weight Mw below 500 000 g/mol, preferably below 450 000 g/mol, more preferably below 400 000 g/mol, still more preferably below 400 000 g/mol, advantageously below 350 000 g/mol, more advantageously below 300 000 g/mol and still more advantageously below 250 000 g/mol and most advantageously below 200 000 g/mol.

Preferably the mass average molecular weight Mw of polymer (C1) is between 10 500 g/mol and 450 000 g/mol, more preferable between 11 000 g/mol and 400 000 g/mol and even more preferably between 12 000 g/mol and 350 000 g/mol advantageously between 13 000 g/mol and 300 000 g/mol, more advantageously between 14 000 g/mol and 250 000 g/mol and most advantageously between 15 000 g/mol and 200 000 g/mol.

In a first advantageously embodiment the mass average molecular weight Mw of the (meth)acrylic polymer MP1 is between 10 500 g/mol and 200 000 g/mol, more preferable between 11 000 g/mol and 190 000 g/mol and even more preferably between 12 000 g/mol and 180 000 g/mol advantageously between 13 000 g/mol and 150 000 g/mol, more advantageously between 14 000 g/mol and 135 000 g/mol and most advantageously between 15 000 g/mol and 120 000 g/mol.

In a second advantageously embodiment the mass average molecular weight Mw of the (meth)acrylic polymer MP1 is between 15 000 g/mol and 450 000 g/mol, more preferable between 16 000 g/mol and 400 000 g/mol and even more preferably between 17 000 g/mol and 350 000 g/mol advantageously between 18 000 g/mol and 300 000 g/mol, more advantageously between 19 000 g/mol and 250 000 g/mol and most advantageously between 20 000 g/mol and 200 000 g/mol.

Preferably the polymer (C1) is a copolymer comprising (meth)acrylic monomers at least one of the monomers is comprising an alicyclic hydrocarbon group with a carbon number from 3 to 20.

With further regard to the polymer (C1), mention may be made of copolymers comprising monomers with double bonds and/or vinyl monomers at least one of the monomers is either comprising an alicyclic hydrocarbon group with a carbon number from 3 to 20 or is chosen according to its Hansen solubility parameter δₚ<10 MPa^{1/2}. Preferably the polymer (C1) is a (meth)acrylic copolymer, meaning that at least 50 wt % of the monomer units of the polymer (C1) are (meth)acrylic.

The copolymer (C1) comprises a comonomer (Mc_{c1}) either said comonomer (Mc_{c1}) is comprising an alicyclic hydrocarbon group with a carbon number from 3 to 20 or said comonomer (Mc_{c1}) is having a Hansen solubility parameter δₚ<10 MPa^{1/2}. The comonomer (Mc_{c1}) in the copolymer (C1) can present between 1 wt % and 99 wt %, preferably between 1 wt % and 90 wt % and more preferably between 1 wt % and 50 wt %. Preferably the Hansen solubility parameter of comonomer (Mc_{c1}) δₚ<9 MPa^{1/2}.

In a first still more preferred embodiment the copolymer the copolymer (C1) comprises between 1 wt % and 40 wt % of comonomer units from comonomer (Mc_{c1}) comprising an alicyclic hydrocarbon group with a carbon number from 3 to 20. The comonomer (Mc_{c1}) comprising an alicyclic hydrocarbon group with a carbon number from 3 to 20 is preferably a (meth)acrylic monomer.

In a second still more preferred embodiment the copolymer (C1) comprises between 1 wt % and 40 wt % comonomer (Mc_{c1}) having a Hansen solubility parameter δₚ<10 MPa^{1/2}. The comonomer (Mc_{c1}) is preferably a (meth)acrylic monomer.

In a third still more preferred embodiment the copolymer (C1) comprises between 1 wt % and 40 wt % of a comonomer (Mc_{c1}) comprising an alicyclic hydrocarbon group with a carbon number from 3 to 20 and having a Hansen solubility parameter δₚ<10 MPa^{1/2}. The comonomer (Mc_{c1}) is preferably a (meth)acrylic monomer.

In a fourth still more preferred embodiment the copolymer (C1) comprises between 10 wt % and 40 wt % of a comonomer (Mc_{c1}) comprising an alicyclic hydrocarbon group with a carbon number from 3 to 20.

In a fifth still more preferred embodiment the copolymer (C1) comprises between 20 wt % and 40 wt % of a comonomer (Mc_{c1}) comprising an alicyclic hydrocarbon group with a carbon number from 3 to 20.

In a sixth still more preferred embodiment the copolymer (C1) comprises between 5 wt % and 35 wt % of a comonomer (Mc_{c1}) comprising an alicyclic hydrocarbon group with a carbon number from 3 to 20.

In an seventh still more preferred embodiment the copolymer (C1) comprises between 10 wt % and 40 wt % of a comonomer (Mc_{c1}) either comprising an alicyclic hydrocarbon group with a carbon number from 3 to 20 or having a Hansen solubility parameter δₚ<9 MPa^{1/2}. The comonomer (Mc_{c1}) is preferably a (meth)acrylic monomer.

In an eight still more preferred embodiment the copolymer (C1) comprises between 10 wt % and 40 wt % of a comonomer (Mc_{c1}) either comprising an alicyclic hydrocarbon group with a carbon number from 3 to 20 or having a Hansen solubility parameter δₚ<10 MPa^{1/2}. The comonomer (Mc_{c1}) is preferably a (meth)acrylic monomer.

In a ninth still more preferred embodiment the copolymer (C1) comprises between 20 wt % and 40 wt % of a comonomer (Mc_{c1}) either comprising an alicyclic hydrocarbon group with a carbon number from 3 to 20 or having a Hansen solubility parameter δₚ<10 MPa^{1/2}. The comonomer (Mc_{c1}) is preferably a (meth)acrylic monomer.

In a tenth still more preferred embodiment the copolymer (C1) comprises between 5 wt % and 35 wt % of a comonomer (Mc_{c1}) either comprising an alicyclic hydrocarbon group with a carbon number from 3 to 20 or having a Hansen solubility parameter δₚ<10 MPa^{1/2}. The comonomer (Mc_{c1}) is preferably a (meth)acrylic monomer.

Most preferably the acrylic or (meth)acrylic comonomers (Mc_{c2}) of the copolymer (C1) are chosen from methyl acrylate, ethyl acrylate, methyl methacrylate, ethyl methacrylate, butyl methacrylate and mixtures thereof, as long as copolymer (C1) is having a glass transition temperature of at least 30° C.

Preferably the glass transition temperature Tg of the copolymer (C1) is between 30° C. and 150° C. The glass transition temperature of the copolymer (C1) is more preferably between 40° C. and 150° C., advantageously between 45° C. and 150° C. and more advantageously between 50° C. and 150° C.

Preferably the copolymer (C1) is not crosslinked.

Preferably the copolymer (C1) is not grafted on any of the polymers (A1) or (B1), especially if it is part of the multistage polymer (MP1). By not grafted is meant that at least 50 wt % of the copolymer (C1) in the multistage polymer (MP1) can be solubilized in a solvent of the copolymer (C1). Preferably at least 75 wt % of the copolymer (C1) in the multistage polymer (MP1) can be solubilized in a solvent of the copolymer (C1).

The copolymer (C1) having a glass transition temperature of at least 30° C. comprises monomer units, that have been polymerized. The copolymer (C1) in general and in the respective embodiments is prepared from the respective monomers or monomer mixtures (Cₘ) including comonomers (Mc_{c1}) and (Mc_{c2}), yielding to the monomer units comprised copolymer (C1).

In a first preferred embodiment the monomer units comprising an alicyclic hydrocarbon group with a carbon number from 3 to 20 are (meth)acrylic monomers.

In a second preferred embodiment the carbon number in the alicyclic hydrocarbon group of the monomer units is from 6 to 20.

The monomer units comprising the alicyclic hydrocarbon group is chosen from the group of cyclohexyl acrylate, cyclohexyl methacrylate, 4-tertbutyl cyclohexyl acrylate, trimethyl cyclohexyl acrylate, bornyl acylate, bornyl methacrylate, norbornyl acylate, norbornyl methacrylate, isobornyl acrylate, isobornyl methacrylate, fenchyl acrylate, fenchyl methacrylate, dicyclopentanyl acrylate, dicyclopentanyl methacrylate, dicyclopentenyl acrylate, dicyclopentenyl methacrylate, adamantyl acrylate, adamantyl methacrylate, dimethyl adamantyl acrylate, dimethyl adamantyl methacrylate, cyclodecyl acrylate, cyclodecyl methacrylate.

The monomer units comprising an alicyclic hydrocarbon group with a carbon number from 3 to 20 or is chosen according to its Hansen solubility parameter δₚ<10 MPa^{1/2} in the copolymer (B1) and (C1) can be the same or different.

In a first preferred embodiment the monomer units comprising an alicyclic hydrocarbon group with a carbon number from 3 to 20 or is chosen according to its Hansen solubility parameter δₚ<10 MPa^{1/2} in the polymer (B1) and (C1) are the same units.

In a second preferred embodiment the monomer units comprising an alicyclic hydrocarbon group with a carbon number from 3 to 20 or is chosen according to its Hansen solubility parameter δₚ<10 MPa^{1/2} in the polymer (B1) and (C1) are at least 50 wt % the same.

In a third preferred embodiment the monomer units comprising an alicyclic hydrocarbon group with a carbon number from 3 to 20 or is chosen according to its Hansen solubility parameter δₚ<10 MPa^{1/2} in the polymer (B1) and (C1) are at less than 50 wt % the same.

Preferably the Hansen solubility parameter &p has a value of less than 9.5 MPa^{1/2} (δₚ<9.5 MPa^{1/2}) for all embodiments.

More preferably the Hansen solubility parameter &p has a value of less than 9 MPa^{1/2} (δₚ<9 MPa^{1/2}) for all embodiments.

The respective preferred and advantageous embodiments of all the different characteristics of the polymers (A1), (B1) and (C1) and its respective monomers, can be combined in any combination.

The multistage polymer (MP1) is obtained by a multistage process comprising at least two stages. At least the component a) and the component b) of composition (PC1) are part of a multistage polymer (MP1).

Preferably the polymer (A1) having a glass transition temperature below 10° C. made during the stage (A), is made before stage (B) or is the first stage of the multistage process.

Preferably the copolymer (B1) having a glass transition temperature over 60° C. made during the stage (B) is made after the stage (A) of the multistage process.

If the copolymer (C1) is part of the multistage polymer (MP1) as well, preferably the copolymer (C1) having a glass transition temperature of at least 30° C. made during the stage (C) is made after the stage (B) of the multistage process

In a first preferred embodiment the copolymer (B1) having a glass transition temperature of at least 60° C. is an intermediate layer of the polymer particle having the multilayer structure.

In this first preferred embodiment the copolymer (C1) having a glass transition temperature over 30° C. made during the stage (C), is made after the stage (B) of the multistage process.

More preferably the copolymer (C1) having a glass transition temperature over 30° C. made during the stage (C) is the external layer of the multistage polymer (MP1) or the primary polymer particle having the multilayer structure.

There could be additional intermediate stages, either between stage (A) and stage (B) and/or between stage (B) and stage (C).

The copolymer (C1) and the copolymer (B1) are not the same polymer, even if their composition could be very close and some of their characteristics are overlapping. The essential difference is that the copolymer (B1) is always part of the multistage polymer (MP1).

This is more explained in the process for preparing the polymeric composition (PC1) according to the invention comprising the copolymer (C1) and the multi stage polymer (MP1).

The weight ratio r of the copolymer (C1) of the external layer comprised in stage (C) in relation to the complete polymer particle is at least 5 wt %, more preferably at least 7 wt % and still more preferably at least 10 wt %.

According to the invention the ratio r of the external stage (C) comprising copolymer (C1) in relation to the complete polymer particle is at most 40 w %.

Preferably the ratio of copolymer (C1) in view of the primary polymer particle is between 5 wt % and 30 wt % and preferably between 5 wt % and 20 wt %.

In a second preferred embodiment the copolymer (B1) having a glass transition temperature of at least 60° C. is the external layer of the primary polymer particle having the multilayer structure in other words the multistage polymer (MP1).

Preferably at least a part of the copolymer (B1) of layer (B) is grafted on the polymer made in the previous layer. If there are only two stages (A) and (B) comprising polymer (A1) and (B1) respectively, a part of copolymer (B1) is grafted on polymer (A1). More preferably at least 50 wt % of polymer (B1) is grafted. The ratio of grafting can be determined by extraction with a solvent for the copolymer (B1) and gravimetric measurement before and after extraction to determine the non-grafted quantity.

The glass transition temperature Tg of the respective polymers can be estimated for example by dynamic methods as thermo mechanical analysis.

In order to obtain a sample of the respective polymers (A1), (B1) and (C1) they can be prepared alone, and not by a multistage process, for estimating and measuring more easily the glass transition temperature Tg individually of the respective polymers of the respective stages. The copolymer (C1) can be extracted for estimating and measuring the glass transition temperature Tg and or the molecular weight.

Preferably the polymer composition of the invention if in form of a powder comprises no solvents. By no solvents is meant that eventually present solvent make up less than 1 wt % of the composition. The monomers of the synthesis of the respective polymers are not considered as solvents. The residual monomers in the composition present less than 2 wt % of the composition.

Preferably the polymer composition according to the invention if in form of a powder is dry. By dry is meant that the polymer composition according to the present invention comprises less than 3 wt % humidity and preferably less than 1.5 wt % humidity and more preferably less than 1.2 wt % humidity.

The humidity can be measured by a thermo balance that heats the polymer composition and measures the weight loss.

The composition according to the invention in form of a powder does not comprise any voluntary added solvent. Eventually residual monomer from the polymerization of the respective monomers and water are not considered as solvents.

The polymer composition (PC1), if in form of a polymer powder (POW1) of the invention comprises polymeric particles PAR. If there are several different kind of particles they are called respectively PAR1, PAR2, ect. The polymeric particles PAR make up at least 50 wt % of the polymer powder composition (POW1). More preferably the polymeric particles PAR1 make up at least 60 wt %, still more preferably at least 70 wt % of the polymer powder composition POW1.

In a first preferred embodiment, the polymer composition (PC1) in form of a polymer powder (POW1) of the invention consists only of polymeric particles PAR1. The polymeric particles PAR1 consists of a multistage polymer (MP1) that comprises the component a), b) and c).

In a second preferred embodiment, the polymer composition (PC1) in form of a polymer powder (POW1) of the invention comprises at least 60 wt % of polymeric particles PAR1. The polymeric particles PAR1 consists of a multistage polymer (MP1) that comprises at least the components a) and b).

In a third preferred embodiment, the polymer composition (PC1) in form of a polymer powder (POW1) of the invention comprises polymeric particles PAR1. The polymeric particles PAR1 consists of a multistage polymer (MP1) that comprises the component a), b) and c).

In a fourth preferred embodiment the polymer composition (PC1) in form of a polymer powder POW1 of the invention comprises two different kind of particles PAR1 and PAR2.

The polymeric particles PAR1 consists of the multistage polymer (MP1) that comprises the component a) and b). The polymeric particles PAR2 comprise or consists of the polymer (C1).

With regard to a first preferred process for manufacturing the polymer composition (PC1) according to the invention it comprises the steps of
a) polymerizing by emulsion polymerization of a monomer or monomer mixture (Aₘ) to obtain one layer in stage (A) comprising polymer (A1) having a glass transition temperature of less than 10° C.,
b) polymerizing by emulsion polymerization of a monomer or monomer mixture (Bₘ) to obtain layer in stage (B) comprising a polymer (B1) having a glass transition temperature of at least 60° C.,
c) polymerizing by emulsion polymerization of a monomer or monomer mixture (Cₘ) to obtain a layer in stage (C) comprising a polymer (C1) having a glass transition temperature of at least 30° C.,
d) agglomerating the composition obtained in steps a) to c).

Preferably the step a) is made before step b).

More preferably step b) is performed in presence of the polymer (A1) obtained in step a).

Advantageously the first preferred process for manufacturing the polymer composition (PC1) according to the invention is a multistep process comprises the steps one after the other of
a) polymerizing by emulsion polymerization of a monomer or monomer mixture (Aₘ) to obtain one layer in stage (A) comprising polymer (A1) having a glass transition temperature of less than 10° C.,
b) polymerizing by emulsion polymerization of a monomer or monomer mixture (Bₘ) to obtain layer in stage (B) comprising a polymer (B1) having a glass transition temperature of at least 60° C.
c) polymerizing by emulsion polymerization of a monomer or monomer mixture (Cₘ) to obtain a layer in stage (C) comprising a polymer (C1) having a glass transition temperature of at least 30° C.,
d) agglomerating the composition obtained in steps a) to c).

Preferably the steps a), b), c) and d) are performed in that order. As emulsion polymerization is used, the polymer composition at the end of the polymerization is obtained as an aqueous dispersion.

The respective monomers or monomer mixtures (Aₘ), (Bₘ) and (Cₘ) for forming the layers in the stages (A), (B) and (C) respectively comprising the polymers (A1), (B1) and (C1) respectively, are the same as defined before. The monomers or monomer mixtures (Aₘ), (Bₘ) and (Cₘ) comprise the respective monomers that are as polymerized monomer units in the polymer chain of the respective polymers (A1), (B1) and (C1). The characteristics of the polymers (A1), (B1) and (C1) respectively, are the same as defined before.

With regard to a second preferred process for manufacturing the polymeric composition (PC1) comprising the polymer (C1) and the multi stage polymer (MP1), it comprises the steps of
a) polymerizing by emulsion polymerization of a monomer or monomer mixture (Aₘ) to obtain one layer in stage (A) comprising polymer (A1) having a glass transition temperature of less than 10° C.,
b) polymerizing by emulsion polymerization of a monomer or monomer mixture (Bₘ) to obtain layer in stage (B) comprising a polymer (B1) having a glass transition temperature of at least 60° C.,
both together steps a) and b) giving a multistage polymer (MP1) and step
c) blending multistage polymer (MP1) with a polymer (C1) having a glass transition temperature of at least 30° C.,
d) agglomerating the composition obtained in steps a) to c).

Preferably, the polymer (C1) is in form of an aqueous dispersion. The aqueous dispersion comprises the polymer (C1) in form of polymeric particles.

With regard to a third preferred process for manufacturing the polymeric composition (PC1) comprising the polymer (C1) and the multi stage polymer (MP1), it comprises the step of
a) providing a polymer (C1) having a glass transition temperature of at least 30° C. and a multistage polymer (MP1) comprising one stage (A) comprising a polymer (A1) having a glass transition temperature of less than 10° C. and one stage (B) comprising a polymer (B1) having a glass transition temperature of at least 60° C.,
b) mixing or blending of the polymer (C1) and the multi stage polymer (MP1),
c) agglomerating the composition obtained in steps b)
   wherein the polymer (C1) and the multi stage polymer (MP1) in step b) are in form of a dispersion in aqueous phase. The respective aqueous dispersions comprises the polymer (C1) and the multi stage polymer (MP1) in form of polymeric particles.

Preferably the multi stage polymer (MP1) and the polymer (C1) are already provided as an aqueous dispersion.

The quantities of the aqueous dispersion of the polymer (C1) and the aqueous dispersion of the multi stage polymer (MP1) are chosen in a way that the weight ratio of the multi stage polymer based on solid part only in the obtained mixture is at least 60 wt %, preferably at least 65 wt %, more preferably at least 68 wt % and advantageously at least 70 wt %.

The quantities of the aqueous dispersion of the polymer (C1) and the aqueous dispersion of the multi stage polymer (MP1) are chosen in a way that the weight ratio of the multi stage polymer based on solid part only in the obtained mixture is at most 99 wt %, preferably at most 95 wt % and more preferably at most 90 wt %.

The quantities of the aqueous dispersion of the polymer (C1) and the aqueous dispersion of the multi stage polymer are chosen in a way that the weight ratio of the multi stage polymer based on solid part only in the obtained mixture is between 60 wt % and 99 wt %, preferably between 65 wt % and 95 wt % and more preferably between 68 wt % and 90 wt %.

The preferred processes for manufacturing the polymer composition (PC1) comprising the polymer (C1) and the multi stage polymer (MP1) yields to the polymer powder POW1. The polymer powder POW1 is in form of grains (large particles). The polymer powder grain or particle comprises agglomerated primary polymer particles made by multistage process comprising the multistage polymer (MP1) and the polymer (C1) or agglomerated primary polymer particles comprising the multistage polymer (MP1) and the polymer (C1).

The agglomeration step can be made by coagulation or by atomization.

For the preferred processes coagulation is preferred in agglomerating step.

The aqueous composition comprising the multi stage polymer (MP1) and the polymer (C1), before starting the coagulation, has a solid content below 35 wt %. If the solid content is higher than 35 wt %, water is added in order to adapt the solid content. Preferably the solid content is below 34 wt %, more preferably below 33 wt % and advantageously below 32 wt %.

The solid content is measured or estimated gravimetrically, by weighting before and after complete evaporation of water.

In a first preferred embodiment the solid content of aqueous composition comprising the multi stage polymer (MP1) and the polymer (C1), before starting the coagulation, is between 5 wt % and 35 wt %, more preferably between 6 wt % and 34 wt %, still more preferably between 7 wt % and 33 wt % and advantageously between 8 wt % and 32 wt %.

In a second preferred embodiment the solid content of aqueous composition comprising the multi stage polymer (MP1) and the polymer (C1), before starting the coagulation, is between 20 wt % and 35 wt %, more preferably between 20 wt % and 34 wt %, still more preferably between 20 wt % and 33 wt % and advantageously between 20 wt % and 32 wt %.

In a third preferred embodiment the solid content of aqueous composition comprising the multi stage polymer (MP1) and the polymer (C1), before starting the coagulation, is between 5 wt % and 20 wt %, more preferably between 6 wt % and 20 wt %, still more preferably between 7 wt % and 20 wt % and advantageously between 8 wt % and 20 wt %.

In a fourth preferred embodiment the solid content of aqueous composition comprising the multi stage polymer (MP1) and the polymer (C1), before starting the coagulation, is between 10 wt % and 25 wt %, more preferably between 11 t % and 24 wt %, still more preferably between 12 wt % and 23 wt % and advantageously between 13 wt % and 22 wt %.

In a fifth preferred embodiment the solid content of aqueous composition comprising the multi stage polymer (MP1) and the polymer (C1), before starting the coagulation, is between 15 wt % and 27 wt %, more preferably between 17 wt % and 27 wt %, still more preferably between 19 wt % and 27 wt % and advantageously between 21 wt % and 27 wt %.

The coagulation can be made with a salt or an inorganic acid.

In a first preferred embodiment, the coagulation is made with an inorganic acid.

The process for manufacturing the polymer composition (PC1) according to the invention can comprise optionally the additional step e) of drying of the polymer composition.

Preferably after the drying step an e) the polymer composition comprises less than 3 wt %, more preferably less than 1.5 wt % advantageously less than 1.2% of humidity or water.

The humidity of a polymer composition can be measure with a thermo balance.

The drying of the polymer can be made in an oven or vacuum oven with heating of the composition for 48 hours at 50° C.

The liquid composition LC1 of the eighth aspect of the invention is a precurser for thermosetting polymers or thermoplastic polymers. This can be a monomer, a mixture of monomers, a polymerizable or curable oligomer, a mixture of polymerizable or curable oligomer with momomer(s), or a mixture of polymers with momomer(s), which are liquid at 25° C. Preferably the liquid has a dynamic viscosity of less than 1000 Pa*s, and more preferably between 0.5 mPa*s and 1000 Pa*s. The value of the dynamic viscosity is taken at a shear rate of 1 1/s. The viscosity is measured with a rheometer.

For example the liquid composition LC1 can be chosen from compositions for preparing vinyl ester, unsaturated polyester or epoxy resin; or it can be for example a styrenic monomer or an (meth)arylic monomer, or a mixture thereof or a liquid composition comprising said monomers.

In one embodiment the liquid composition LC1 comprises at least one (meth)arylic monomer (M2a), the (meth)arylic monomer is chosen from cyclohexyl acrylate, cyclohexyl methacrylate, 4-tertbutyl cyclohexyl acrylate, trimethyl cyclohexyl acrylate, bornyl acylate, bornyl methacrylate, norbornyl acylate, norbornyl methacrylate, isobornyl acrylate, isobornyl methacrylate, fenchyl acrylate, fenchyl methacrylate, dicyclopentanyl acrylate, dicyclopentanyl methacrylate, dicyclopentenyl acrylate, dicyclopentenyl methacrylate, adamantyl acrylate, adamantyl methacrylate, dimethyl adamantyl acrylate, dimethyl adamantyl methacrylate, cyclodecyl acrylate, cyclodecyl methacrylate, or mixtures thereof. Preferably the polymeric composition (PC1) represents between 0.5 wt % and 50 wt % of the composition comprising liquid composition LC1 and polymeric composition (PC1), more preferably between 0.5 wt % and 45 wt %, still more preferably between 1 wt % and 40 wt %.

In one embodiment the liquid composition LC1 is comprising
a) the polymer composition (PC1) and
b) a monomer (M2b)
   wherein the polymer composition (PC1) to monomer (M2) ratio by weight in the liquid composition LC1 is between 1/99 and 25/75.

Preferably the monomer (M2b) is a (meth)arylic monomer. More preferably the monomer (M2b) is having a Hansen solubility parameter δₚ<10 MPa^{1/2}.

The present invention relates also to the use of the polymer composition (PC1) in form of the polymer powder according to the invention as an impact modifier in polymers, in order to obtain an impact modified polymer composition. Preferably the polymers are thermosetting polymers or thermoplastic polymers or its precursors.

The present invention relates also to the use of the polymer composition (PC1) in the field of compositions for UV curing, 3D printing and adhesives.

### [Methods of Evaluation]

### Glass Transition Temperature

The glass transitions (Tg) of the polymers are measured with equipment able to realize a thermo mechanical analysis. A RDAII “RHEOMETRICS DYNAMIC ANALYSER” proposed by the Rheometrics Company has been used. The thermo mechanical analysis measures precisely the visco-elastics changes of a sample in function of the temperature, the strain or the deformation applied. The apparatus records continuously, the sample deformation, keeping the stain fixed, during a controlled program of temperature variation.

The results are obtained by drawing, as a function of the temperature, the elastic modulus (G′), the loss modulus and the tan delta. The Tg is the highest temperature value read in the tan delta curve, when the derived of tan delta is equal to zero.

### Molecular Weight

The mass average molecular weight (Mw) of the polymers is measured with by size exclusion chromatography (SEC). Polystyrene standards are used for calibration. The polymer is dissolved in THE at a concentration of 1 g/L. The chromatography column uses modified silica. The flow is 1 ml/min and a detector for refractive index is used.

### Particle Size Analysis

The particle size of the primary particles after the multistage polymerization is measured with a Zetasizer from Malvern using dynamic lightscattering. As result the volume average particle size (diameter) is taken.

The particle size of the polymer powder after recovering is measured with Malvern Mastersizer 3000 from MALVERN with laser diffraction.

For the estimation of volume average powder particle size, particle size distribution and ratio of fine particles a Malvern Mastersizer 3000 apparatus with a 300 mm lenses, measuring a range from 0.5-880 μm is used.

The Hansen solubility parameters, and especially the Hansen solubility parameter &p are estimated according to the method as described in WO2020/001835.

### Apparent Density

The norm ISO 60:1977 is used. The sample is pured through a specified funnel into a measuring cylinder of 100 cubic centimeter capacity, the excess is removed with a straightedge and the mass of the contents is determined by weighing.

### Viscosity

The viscosity can be easily measured with a Rheometer or viscosimeter. The dynamic viscosity is measured at 25° C. If the liquid has a Newtonian behaviour, meaning no shear thinning, the dynamic viscosity is independent of the shearing in a rheometer or the speed of the mobile in a viscometer. If the liquid composition has a non-Newtonian behaviour, meaning shear thinning, the dynamic viscosity is measured at a shear rate of 1 s⁻¹ at 25° C.

### Examples

A polymer composition (PC) in form of a core-shell multistage polymer comprising a core and two shell layers are prepared according to the process as described in WO2020/260638 for comparative example 1. For example 1 however 30 wt % of the MMA in the synthesis of the two shell layers of comparative example 1 is substituted by isobornyl acrylate (IBOA).

Both obtained products are coagulated with sulfucic acid and dried.

TABLE 1

| | | | | | | Mw |
|---|---|---|---|---|---|---|
| | | Particle | | | Extracted | extracted |
| | CS | Size | 1^{st} shell | 2nd shell | polymer/ | polymer/ |
| Reference | ratio | [nm] | Polymer (B1) | Polymer (C1) | [%] | [g/mol] |
| Comparative | 71/29 | 177 | PMMA - | PMMA - | 12 | 35 000 |
| Example | | | crosslinked | transfer agent | | |
| Example 1 | 71/29 | 170 | PMMA -IBOA | PMMA-IBOA | 11 | 22000 |
| | | | (70/30) | (70/30)- | | |
| | | | crosslinked | transfer agent | | |

TABLE 2
Powder properties

| | D10/ | D50/ | D90/ | MVA/ | | Porosity/ |
|---|---|---|---|---|---|---|
| Reference | [μm] | [μm] | [μm] | [g/cm3] | pH | [ml/g] |
| Comparitive | 64 | 200 | 520 | 0.20 | 5.6 | 2.45 |
| example 1 | | | | | | |
| example 1 | 88 | 265 | 675 | 0.31 | 6.7 | 1.7 |

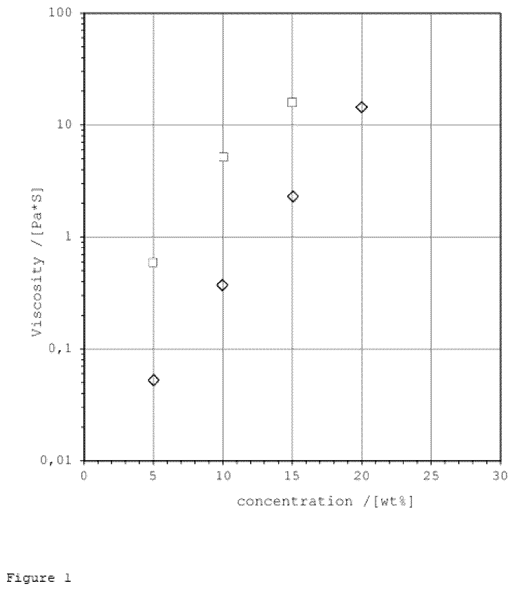

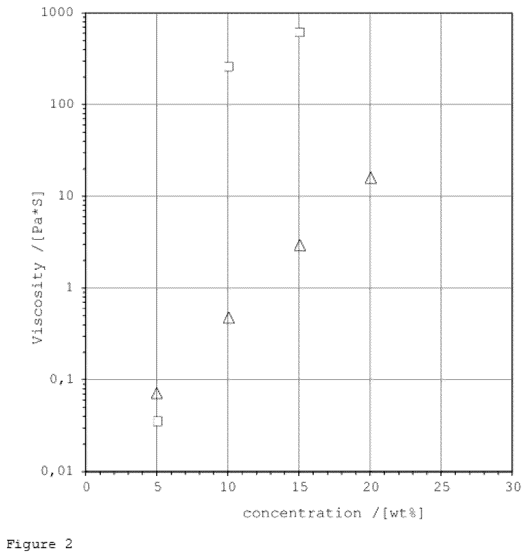

The two powders are tested in different concentrations isobornyl acrylate (FIG. 1) and isobornyl methacrylate (FIG. 2) as monomers. The viscosity in Pa*s at a shear rate of 1/s at 25° C. is given as function of the concentration in wt %. The comparative example 1 are the squares symbols and the example 1 the diamond symbols. The results are shown in FIGS. 1 to 2.

The composition according to the invention yields to a much significant lower viscosity of the liquid compositions. It can be dispersed at much higher concentration.

1. A polymer composition (PC1) comprising
a) a polymer (A1) having a glass transition temperature of less than 10° C.,
b) a polymer (B1) having a glass transition temperature of at least 60° C., and
c) a polymer (C1) having a glass transition temperature of at least 30° C., said polymer (C1) represents at most 40 wt % of a composition based on a), b) and c) only,
wherein at least the component a) and the component b) of composition (PC1) are part of a multistage polymer (MP1),
wherein the polymer (C1) has a mass average molecular weight Mw between 10 000 g/mol and 500 000 g/mol
wherein either the polymer (B1) and the polymer (C1) comprise monomer units comprising an alicyclic hydrocarbon group with a carbon number from 3 to 20 or in that the polymer (B1) and the polymer (C1) comprise monomer units from polymerized comonomers (MC_{b1}) and (Mc_{c1}) respectively both comonomers having a Hansen solubility parameter δₚ<10 MPa^{1/2}.

2. The polymer composition (PC1) according to claim 1, wherein the polymer (B1) and the polymer (C1) comprise monomer units comprising an alicyclic hydrocarbon group with a carbon number from 3 to 20.

3. The polymer composition (PC1) according to claim 1, wherein the polymer (B1) and the polymer (C1) comprise monomer units from polymerized comonomers (Mc_{b1}) and (Mc_{c1}) respectively both comonomers having a Hansen solubility parameter δₚ<10 MPa^{1/2}.

4. The polymer composition (PC1) according to claim 1, wherein the polymer (B1) and the polymer (C1) comprise monomer units comprising an alicyclic hydrocarbon group with a carbon number from 3 to 20 and monomer units from polymerized comonomers (Mc_{b1}) and (Mc_{c1}) respectively both comonomers having a Hansen solubility parameter δₚ<10 MPa^{1/2}.

5. The polymeric composition according to claim 1, wherein each of the polymer (B1) and the polymer (C1) comprises between 1 wt % and 90 wt % monomer units comprising the alicyclic hydrocarbon group with a carbon number from 3 to 20.

6. The polymer composition (PC1) according to claim 1, wherein the carbon number in the alicyclic hydrocarbon group of the monomer units is from 6 to 20.

7. The polymeric composition according to claim 1, wherein the each of the polymer (B1) and the polymer (C1) comprises between 1 wt % and 50 wt % monomer units comprising the alicyclic hydrocarbon group with a carbon number from 3 to 20.

8. The polymeric composition according to claim 1, wherein the each of the polymer (B1) and the polymer (C1) comprises between 5 wt % and 35 wt % monomer units comprising the alicyclic hydrocarbon group with a carbon number from 3 to 20.

9. The polymeric composition (PC1) according to claim 1, wherein the monomer units comprising an alicyclic hydrocarbon group with a carbon number from 3 to 20 is chosen from cyclohexyl acrylate, cyclohexyl methacrylate, 4-tertbutyl cyclohexyl acrylate, trimethyl cyclohexyl acrylate, norbornyl acylate, norbornyl methacrylate, isobornyl acrylate, isobornyl methacrylate, fenchyl acrylate, fenchyl methacrylate, dicyclopentanyl acrylate, dicyclopentanyl methacrylate, dicyclopentenyl acrylate, dicyclopentenyl methacrylate, adamantyl acrylate, adamantyl methacrylate, dimethyl admantyl acrylate, dimethyl admantyl methacrylate, cyclodecyl acrylate, cyclodecyl methacrylate.

10. The polymeric composition (PC1) according to claim 1, wherein polymeric composition (PC1) in form of a porous polymer powder POW1 is having total intruded volume of at least 1.2 ml/g as measured by mercury porosimetry.

11. The polymeric composition (PC1) according to claim 1, wherein polymeric composition (PC1) in form of a porous polymer powder POW1 is having total intruded volume of at most 10 ml/g as measured by mercury porosimetry.

12. The polymeric composition (PC1) according to claim 1, wherein polymeric composition (PC1) in form of a porous polymer powder POW1 is having total intruded volume between 1.2 ml/g and 10 ml/g.

13. The polymeric composition (PC1) according to claim 1, wherein the component c) represents between 4 wt % and 40 wt % of the composition based on a) b) and c).

14. The polymeric composition (PC1) according to claim 1, wherein the monomer units comprising an alicyclic hydrocarbon group with a carbon number from 3 to 20 or is chosen according to its Hansen solubility parameter δₚ<10 MPa^{1/2} in the polymer (B1) and (C1) are the same units.

15. The polymeric composition (PC1) according to claim 1, wherein the monomer units comprising an alicyclic hydrocarbon group with a carbon number from 3 to 20 or is chosen according to its Hansen solubility parameter δₚ<10 MPa^{1/2} in the polymer (B1) and (C1) are at less than 50 wt % the same.

16. A process for manufacturing the polymer composition according to claim 1, comprising the steps of
a) polymerizing by emulsion polymerization of a monomer or monomer mixture (Aₘ) to obtain one layer in a stage (A) comprising polymer (A1) having a glass transition temperature of less than 10° C.,
b) polymerizing by emulsion polymerization of a monomer or monomer mixture (Bₘ) to obtain a layer in a stage (B) comprising a polymer (B1) having a glass transition temperature of at least 60° C.,
c) polymerizing by emulsion polymerization of a monomer or monomer mixture (Cₘ) to obtain a layer in a stage (C) comprising a polymer (C1) having a glass transition temperature of at least 30° C. said polymer (C1) represents at most 40 wt % of the composition based on a), b) and c) only;
d) agglomerating the composition obtained in steps a) to c);
wherein the polymer (C1) has a mass average molecular weight Mw between 10 000 g/mol and 500 000 g/mol and in that either the monomer or monomer mixture (Bₘ) and the monomer or monomer mixture (Cₘ), both comprise monomers comprising an alicyclic hydrocarbon group with a carbon number from 3 to 20 or the monomer or monomer mixture (Bₘ) and the monomer or monomer mixture (Cₘ), both comprise comonomers (MC_{b1}) and (Mc_{c1}) respectively both comonomers having a Hansen solubility parameter δₚ<10 MPa^{1/2}.

17. A process for manufacturing the polymer composition according to claim 1, comprising the steps of
a) polymerizing by emulsion polymerization of a monomer or monomer mixture (Aₘ) to obtain one layer in a stage (A) comprising polymer (A1) having a glass transition temperature of less than 10° C.,
b) polymerizing by emulsion polymerization of a monomer or monomer mixture (Bₘ) to obtain layer in a stage (B) comprising a polymer (B1) having a glass transition temperature of at least 60° C.,
both together steps a) and b) giving a multistage polymer (MP1) and a step
c) blending multistage polymer (MP1) with a polymer (C1) having a glass transition temperature of at least 30° C. said polymer (C1) represents at most 40 wt % of the composition based on a), b) and c) only;
d) agglomerating the composition obtained in steps a) to c);
wherein the polymer (C1) has a mass average molecular weight Mw between 10 000 g/mol and 500 000 g/mol and in that either the monomer or monomer mixture (Bₘ) and the monomer or monomer mixture (Cₘ), both comprise monomers comprising an alicyclic hydrocarbon group with a carbon number from 3 to 20 or the monomer or monomer mixture (Bₘ) and the monomer or monomer mixture (Cₘ), both comprise comonomers (MC_{b1}) and (Mc_{c1}) respectively both comonomers having a Hansen solubility parameter δₚ<10 MPa^{1/2}.

18. The process according to claim 16, wherein the agglomeration step is made by coagulation.

19. The process according to claim 18, wherein the coagulation is be made with a salt or an inorganic acid.

20. A method of using the polymer composition (PC1) according to claim 1 as impact modifier.

21. A liquid composition LC1 comprising
a) the polymer composition (PC1) according to claim 1, and
b) a monomer (M2)
wherein the polymer composition (PC1) to monomer (M2) ratio by weight in the liquid composition LC1 is between 1/99 and 25/75.

22. The liquid composition LC1 according to claim 21, wherein the monomer (M2) is chosen from cyclohexyl acrylate, cyclohexyl methacrylate, 4-tertbutyl cyclohexyl acrylate, trimethyl cyclohexyl acrylate, norbornyl acylate, norbornyl methacrylate, isobornyl acrylate, isobornyl methacrylate, fenchyl acrylate, fenchyl methacrylate, dicyclopentanyl acrylate, dicyclopentanyl methacrylate, dicyclopentenyl acrylate, dicyclopentenyl methacrylate, adamantyl acrylate, adamantyl methacrylate, dimethyl admantyl acrylate, dimethyl admantyl methacrylate, cyclodecyl acrylate, cyclodecyl methacrylate or mixtures thereof.

23. A method of using the polymer composition (PC1) according to claim 1 in the field of compositions for UV curing, 3D printing and adhesives.
